(19) United States
(12) Patent Application Publication
(10) Pub. No.: US 2006/0115408 A1
(43) Pub. Date: Jun. 1, 2006

(54) Superfine particulate diamond sintered product of high purity and high hardness and method for production thereof

(76) Inventors: Minoru Akaishi, Ibaraki (JP); Keigo Kawamura, Hokkaido (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/534,826

(22) PCT Filed: Nov. 12, 2003
(86) PCT No.: PCT/JP03/14397

§ 371 Date: Jan. 9, 2006

(30) Foreign Application Priority Data
Nov. 15, 2002 (JP) 2002-332730

(51) Int. Cl. C01B 31/06

(52) U.S. Cl. 423/446

(57) ABSTRACT

Disclosed is a high-purity high-hardness ultrafine-grain diamond sintered body having a grain size of 100 nm or less, which is produced by subjecting an ultrafine-grain natural diamond powder having a grading range of zero to 0.1 μm to a desilication treatment, freeze-drying the desilicated powder in solution, enclosing the freeze-dried powder in a Ta or Mo capsule without a sintering aid, and heating and pressurizing the capsule using an ultrahigh-pressure synthesizing apparatus at a temperature of 1700° C. or more and under a pressure of 8.5 GPa or more, which meet the conditions for diamond to be the thermodynamically stable. The present invention can synthesize a diamond sintered body under a lower pressure than that in a conventional method, with a diamond's original hardness and without containing any sintering aid.

### TECHNICAL FIELD

The present invention relates to a high-purity high-hardness ultrafine-grain diamond sintered body and a production method thereof.

### BACKGROUND ART

Heretofore, there has been known a method for producing a diamond sintered body or a fine-grain diamond sintered body in the presence of a metal sintering aid, such as Co, by use of a conventional ultrahigh-pressure synthesizing apparatus (see the following Patent Publications 1 and 2). There has also been known a method for synthesizing a high-hardness diamond sintered body excellent in heat resistance, which comprises performing a sintering treatment under higher pressure/temperature conditions than those in a conventional treatment, using an alkaline-earth metal carbonate as a sintering aid, instead of the metal sintering aid (see the following Non-Patent Publication 1). However, these sintered bodies have a relatively large grain size of about 5 μm.

The inventors reported a method for producing a fine-grain diamond sintered body, which comprises adding oxalic acid dihydrate serving as a source of a CO₂—H₂O fluid phase into carbonate to prepare a mixed powder, and applying a natural diamond powder having a grading range (distribution range of particle diameter) of zero to 1 μm, onto the mixed powder to form a layered structure (see the following Patent Publication 3 and Non-Patent Publications 2 and 3). However, this production method essentially requires a high temperature of 2000° C. or more.

The inventors also reported a method similar to the above method, which comprises sintering a finer-grain diamond powder, for example, having a grading range of zero to 0.1 μm (see the following Non-Patent Publication 4). In this case, any high-hardness diamond sintered body could not be obtained due to occurrence of abnormal grain growth in diamond.

Recently, an article has been published that discloses a method for synthesizing a diamond sintered body under a pressure of 12 to 25 GPa and at a temperature of 2000 to 2500° C. without a sintering aid through a direct conversion reaction from graphite to diamond. This article reports that the obtained diamond sintered body has light-transparency (see the following Non-Patent Publication 5).

Parent Publication 1: Japanese Patent Publication No. 52-012126

Parent Publication 2: Japanese Patent Publication No. 04-050270

Parent Publication 3: Japanese Patent Laid-Open Publication No. 2002-187775

Non-Patent Publication 1: Diamond and Related Mater., Vol. 5, pp 34-37, Elsevier Science S. A., 1996

Non-Patent Publication 2: Journal of the 41st High Pressure Symposium, p 108, the Japan Society of High Pressure Science and Technology, 2000

Non-Patent Publication 3: Proceedings of the 8th NIRIM International Symposium on Advanced Materials, pp 33-34, the National Institute for Research in Inorganic Materials, 2001

Non-Patent Publication 4: Journal of the 42nd High Pressure Symposium, p 89, the Japan Society of High Pressure Science and Technology, 2001

Non-Patent Publication 5: T. Irifune et al., “Characterization of polycrystalline diamonds synthesized by direct conversion of graphite using multi anvil apparatus, 6th High Pressure Mineral Physics Seminar, 28 Aug. 2002, Verbania, Italy

### DISCLOSURE OF INVENTION

The diamond sintered body containing a sintering aid has difficulty in obtaining light-transparency therein due to the solid sintering aid. Moreover, as compared to an ideal diamond sintered body containing no sintering aid, the sintering-aid-containing diamond sintered body has a lower hardness, because the presence of an occupied volume of the sintering aid leads to decrease in bonding area between diamond grains.

The synthesis of a high-purity diamond sintered body based on the reaction sintering method utilizing the conversion reaction from graphite to diamond is required to be performed under an extremely high pressure of 12 to 25 GPa. Thus, a synthesizable sample currently has a fairly small size of about 1 to 2 mm, and its application range is limited to only a specific field.

All of the conventional diamond sintered bodies contain some kind of metal-based or nonmetal (carbonate)-based sintering aid, and thereby a bonding area between diamond grains is inevitably reduced in proportion to a volume ratio of the sintering aid in the sintered body. Thus, it can be obviously presumed that the conventional diamond sintered bodies is inferior in Vickers hardness as compared to a diamond sintered body containing no sintering aid. Further, the conventional high-purity diamond sintered body requires an extremely high pressure for synthesis thereof.

When such an ultrahigh pressure is imposed on a diamond powder, the diamond powder will be partly graphitized due to co-occurring high temperature, to cause difficulty in forming a bond between diamond grains. A sintering aid has been used for avoiding this problem. The sintering aid is selected from diamond synthesis catalysts. This sintering aid induces partial melting in each of the diamond grains to precipitate diamond on each surface of the diamond grains so as to form a bond between the diamond grains.

The inventors previously developed a method for preparing a diamond powder while preventing the formation of a secondary grain therein. This method comprises, in a final step of subjecting a natural diamond powder to a desilication treatment, enclosing in a container a treatment solution containing the diamond powder dispersed therein, freezing the diamond-powder-containing treatment solution in the container, and successively freeze-drying the diamond powder to obtain a diamond powder.

Further, the inventors invented a method for producing a high-hardness fine-grain diamond sintered body, which comprises sintering the above diamond powder at a temperature of 1700° C. or more in the presence of a sintering aid of carbonate mixed with oxalic acid dihydrate (organic acid sintering aid consisting of carbonate-C—O—H), by use of an ultrahigh-pressure synthesizing apparatus, and filed a patent application [Japanese Patent Application No. 2002-030863 (Japanese Patent Laid-Open Publication No. 2003-226578)]. However, based on the conditions disclosed in this invention, for example, a pressure of 7.7 GPa and a temperature of 1700 to 2300° C., a high-hardness diamond sintered body cannot be synthesized without any use of sintering aids.

It is an object of the present invention to provide a technique for synthesizing a diamond sintered body having a diamond's original hardness and containing no sintering aid, under a lower pressure than that in the conventional methods.

The inventors have found that, through a method comprising subjecting an ultrafine-grain natural diamond powder having a grading range of zero to 0.1 μm to a desilication treatment, freeze-drying the desilicated powder, and sintering the freeze-dried powder at a temperature 1700° C. or more and under a pressure of 8.5 GPa or more without any use of sintering aids, a diamond sintered body can be synthesized with an extremely high hardness as compared to the conventional diamond sintered body using a sintering aid, and a high-purity containing no component resulting from a sintering aid.

Specifically, according to a first aspect of the present invention, there is provided a high-purity high-hardness ultrafine-grain diamond sintered body having a grain size of 100 nm or less, which is produced by subjecting an ultrafine-grain natural diamond powder having a grading range of zero to 0.1 μm to a desilication treatment, freeze-drying the desilicated powder in solution, and sintering the freeze-dried powder without a sintering aid.

The high-purity high-hardness ultrafine-grain diamond sintered body set forth in the first aspect of the present invention may have light-transparency.

According to a second aspect of the present invention, there is provided a method of producing a high-purity high-hardness ultrafine-grain diamond sintered body, which comprises the steps of subjecting an ultrafine-grain natural diamond powder having a grading range of zero to 0.1 μm to a desilication treatment, freeze-drying the desilicated powder in solution, enclosing the freeze-dried powder in a Ta or Mo capsule, and heating and pressurizing the capsule using an ultrahigh-pressure synthesizing apparatus at a temperature of 1700° C. or more and under a pressure of 8.5 GPa or more, which meet the conditions for diamond to be thermodynamically stable, so as to sinter the freeze-dried powder.

In the method set forth in the second aspect of the present invention, the heating and pressurizing step is performed at a temperature of 2150° C. or more and under a pressure of 8.5 GPa or more, whereby the sintered body has light-transparency.

Differently from the conventional diamond sintered body synthesized from a natural diamond powder using a sintering aid, the high-purity high-hardness ultrafine-grain diamond sintered body synthesized by the method of the present invention has excellent characteristics of high hardness and light-transparency. Thus, it is expected to use the diamond sintered body as not only a high-hardness material but also a light-transparent high-hardness material. According to the method of the present invention, the high-purity diamond sintered body having these excellent characteristics can be reliably produced under a lower pressure than that in the conventional methods.

The high-purity high-hardness ultrafine-grain diamond sintered body of the present invention has a nanometer-scale grain size, and exhibits nonconventional excellent characteristic. Thus, it is expected to use the diamond sintered body in a wide range of fields, such as tools for ultraprecision machining and working tools for a difficult-to-machine material.

### BRIEF DESCRIPTION OF DRAWINGS

FIG. 1 is a sectional view showing one example of a sintered-body synthesizing capsule for sintering a diamond powder in a production method of the present invention.

FIGS. 2(A) and 2(B) are electron micrographs showing a fracture surface of a diamond sintered body obtained in Inventive Example 1.

FIG. 3 is an electron micrograph showing light-transparency of a diamond sintered body obtained in Inventive Example 2.

### BEST MODE FOR CARRYING OUT THE INVENTION

A desilicated ultrafine natural diamond powder to be used in producing a diamond sintered body of the present invention is prepared by the following specific process. This process is the same as the method for preparing a diamond powder while preventing the formation of a secondary grain therein, which is disclosed in the Japanese Patent Application No. 2002-030863 (Japanese Patent Laid-Open Publication No. 2003-226578).

A commercially available natural diamond powder having a grading range of zero to 0.1 μm is put in molten sodium hydroxide in a zirconium crucible to convert silicate contained in the diamond as an impurity to water-soluble sodium silicate.

While there is no grain size standard based on a standardized measuring method for finely powdered diamond, natural diamond powders are put on the market according to a grading standard defined by classifying a grading range (μm) into zero to ¼, zero to ½, zero to 1, zero to 2, 1 to 3, 2 to 4, and 4 to 8 (a median grain size is an intermediate value of each grading range). The grading range of the natural diamond powder in this specification is based on such a classification.

Then, the diamond powder is collected from the molten sodium hydroxide into an alkali aqueous solution, and subjected to a neutralization treatment using hydrochloric acid. The diamond powder is rinsed with distilled water several times to remove sodium chloride therefrom.

Then, a solution containing the diamond powder dispersed therein is formed, and aqua regia is added into the solution so as to subject the diamond powder to a hot aqua regia treatment to remove zirconium which could be introduced from the zirconium crucible into the diamond powder. After the hot aqua regia treatment, the diamond powder is rinsed with distilled water three times or more, and then collected into a weak acid solution. The treatment solution containing the diamond powder dispersed therein has a weak acidic property with a pH of about 3 to 5.

The weak acid aqueous solution containing the desilicated diamond powder dispersed therein is put in a container made, for example, of a plastic material, and subjected to a shaking treatment using a shaker for a sufficient time, for example, about 20 to 30 minutes. Then, the container is moved in liquid nitrogen in a stirring manner to freeze the desilicated diamond powder in a short period of time. The time period before the immersion of the container into the liquid nitrogen after taking out of the shaker should be minimized, preferably performed within 30 seconds. This makes it possible to prevent the precipitation of the diamond powder onto the bottom of the plastic container and the formation of secondary grains. The liquid nitrogen is suitable for the freezing treatment, because it is a low-cost material, and capable of readily freezing a solution.

Then, a freeze-drying process is performed as follows. After loosening a cap of the container enclosing the frozen diamond powder, the container is placed in a vacuum atmosphere. When the frozen solution is kept in a vacuum state, weak acid frozen water or ice will be sublimated. The sublimation takes the heat from the container enclosing the frozen diamond powder to allow the diamond powder to be kept in the frozen state. The vaporized water is trapped by a cooling device with a cooling capacity of −100° C. or less, which is interposed in an evacuation line of a vacuum pump. For example, the freeze-drying process for 100 ml of solution containing 15 g of diamond powder requires about four days.

In the above process, the desilicated fine diamond powder enclosed in the container under the condition that it is dispersed in water, or the surface of each diamond grain is covered by water is frozen, and successively freeze-dried so as to prevent the formation of secondary grains. The diamond powder obtained through the freeze-drying process is in a powdered state or formed as discrete grains. That is, significantly differently from a diamond powder obtained through a conventional filtering/heating/drying process, the above process can provide a dry or loose diamond powder having a high fluidity. The powder prepared by the above freeze-drying process consists of primary grains having an average grain size of about 80 nm in an electron microscope observation. While specific numerical conditions have been shown in the above description, they may be appropriately altered as long as a dry or loose diamond powder can be obtained without the formation of secondary grains.

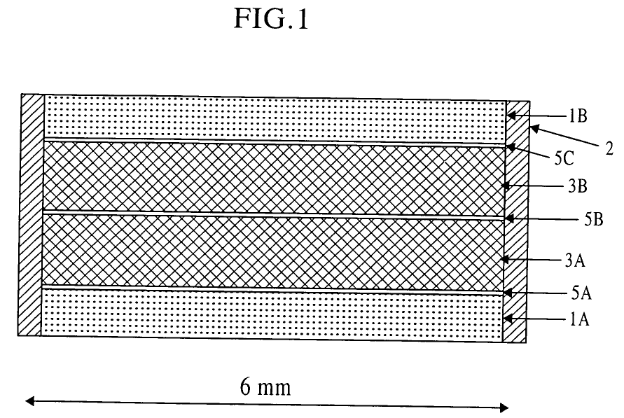

In the diamond sintered body production method of the present invention, the ultrafine natural diamond powder prepared through the above freeze-drying process is used as a starting material. FIG. 1 is a sectional view showing one example of a sintered-body synthesizing capsule for sintering a diamond powder in the production method of the present invention. As shown in FIG. 1, a cylindrical-shaped Ta or Mo capsule 2 has a first graphite disc 1A attached to the bottom thereof to prevent the deformation of the capsule. A first layer 3A of the diamond powder is formed on the graphite disc IA through a Ta or Mo foil 5A under a given compacting pressure, and then a second layer 3B of the same diamond powder is formed on the first diamond powder layer 3A through a Ta or Mo foil 5B under the same compacting pressure. Then, a Ta or Mo foil 5C is placed on the second diamond powder layer 3B, and a second graphite disc 1B is placed on the Ta or Mo foil 5C to prevent the deformation of the capsule. Each of the Ta or Mo foils 5A to 5C is used for separating the diamond powder layers from each other to synthesize a diamond sintered body having a desired thickness, separating the graphite discs from the diamond powder layers, and preventing a pressure medium from getting in the capsule. No sintering aid is used.

This capsule is placed in a pressure medium, and pressurized up to 8.5 GPa or more at room temperature by use of an ultrahigh-pressure apparatus based on a static compression process, such as a conventional belt-type ultrahigh-pressure synthesizing apparatus. Then, under this pressure, the capsule is heated up to a given temperature of 1700° C. or more to perform a sintering treatment. If the pressure is less than 8.5 GPa, a desired high-hardness sintered body cannot be obtained even if the temperature is equal to or greater than 1700° C. Further, if the temperature is less than 1700° C., a desired high-hardness sintered body cannot be obtained even if the pressure is equal to or greater than 8.5 GPa. It is desirable to limit the temperature and pressure to a bare minimum in consideration of the capacity of the apparatus, because excessive temperature or pressure simply leads to deterioration in energy efficiency.

A light-transparent sintered body can be produced by performing the sintering treatment at a temperature of 2150° C. or more. The reason would be that 2150° C. is a temperature allowing graphite to be converted directly to diamond, and the bond between diamond grains is accelerated at a temperature of 2150° C. or more.

When a belt-type ultrahigh-pressure synthesizing apparatus is used as the ultrahigh-pressure apparatus, it is difficult for a graphite heater serving as a heating source of the apparatus to stably achieve a high temperature of 1700° C. or more. As a heater material capable of achieving a high temperature of 2000° C. or more, a titanium carbide-diamond compound sintered body developed by the inventors may be desirably used (patent pending: Japanese Patent Application No. 2002-244629). This titanium carbide-diamond compound sintered body is prepared using a mixed powder of diamond powder and titanium carbide powder as a starting material.

Specifically, a nonstoichiometric titanium carbide powder having a C/Ti ratio ranging from 0.7 to less than I and a grain size of 4 μm or less is selected as the titanium carbide powder, and mixed with a diamond powder to prepare a mixed powder including these powders. The mixed powder is compacted, and subjected to a treatment for binder removal. Then, the mixed powder is sintered in a non-oxidizing atmosphere to induce diffusion bonding between the diamond and the nonstoichiometric titanium carbide. Through this process, a diamond-titanium carbide compound sintered body can be obtained with a given strength and workability allowing the thickness thereof to be adjusted at a desired value through a subsequent grinding process.

According to the present invention, the sintering treatment is performed using the natural diamond powder prepared through the aforementioned freeze-drying process. This makes it possible to readily achieve the syntheses of a high-hardness diamond sintered body having a Vickers hardness of 80 GPa or more, from an ultrafine natural diamond powder having a grading range of zero to 0.1 μm, which has been unachievable by the conventional methods.

### EXAMPLE

The diamond sintered body production method of the present invention will be specifically described in connection with the following examples.

### Inventive Example 1

A commercially available natural diamond powder having a grading range of zero to 0.1 μm was used as a starting material, and a diamond powder was prepared through the aforementioned freeze-drying process. According to an electron microscope observation, it was determined that this diamond powder has an average grain size of 80 nm. A cylindrical-shaped Ta capsule having a wall thickness of 0.2 mm and an outer diameter of 6 mm was prepared, and a first graphite disc having a thickness of 0.5 mm was attached to the bottom of the capsule to prevent the deformation of the capsule. 60 mg of the diamond powder was placed on the first graphite disc through a first Ta foil, and pressed at a compacting pressure of 100 MPa to form a lower diamond powder layer. Further, 60 mg of the diamond powder was placed on the lower diamond powder layer through a second Ta foil, and pressed at the same compacting pressure to form an upper diamond powder layer. Then, a third Ta foil was placed on the upper diamond powder layer, and a second graphite disc having a thickness of 0.5 mm was placed on the third Ta foil to prevent the deformation of the capsule.

Then, the capsule was placed in a pressure medium of cesium chloride, and subjected to a sintering treatment under a pressure of 9.4 GPa at a temperature of 2000° C. for 30 minutes in a belt-type ultrahigh pressure synthesizing apparatus using a titanium carbide-diamond compound sintered body as a heating heater. After completion of the sintering treatment, the capsule was taken out of the synthesizing apparatus.

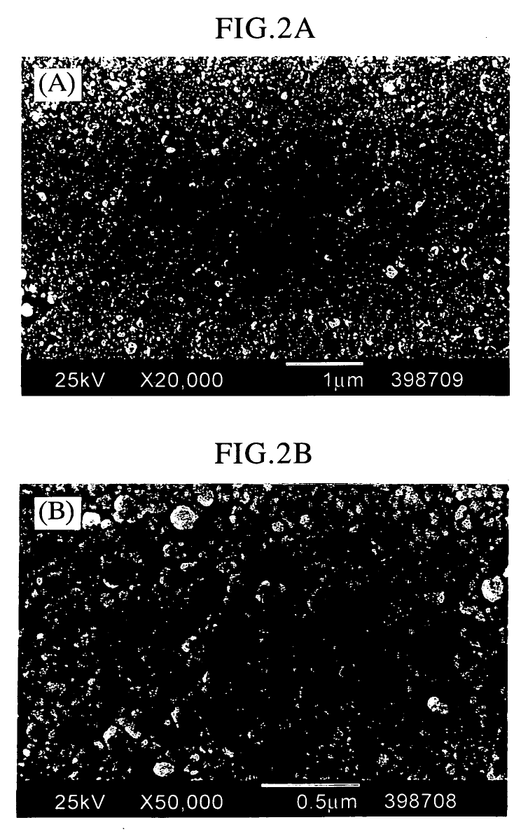

Then, a product, such as TaC, formed on the surface of the sintered body was removed using a hydrofluoric acid-nitric acid solution, and each of top and bottom surfaces of the sintered body was ground using a diamond wheel. After the grinding, the sintered body had an extremely high Vickers hardness of 100 GPa. As shown in FIG. 2(A) and FIG. 2(B) which is a macrophotograph corresponding to FIG. 2(A), according to an electron microscope observation of a fracture surface of the sintered body, it was proven that the sintered body has a homogeneous structure consisting of fine grains with an average grain size of 80 nm.

### Comparative Example 1

Except that a natural diamond powder having a grading range of zero to 1 μm was used as a starting material, a sintered body was produced in the same manner as that in Inventive Example 1. The obtained sintered body had a Vickers hardness of 69 GPa. This hardness is significantly low as compared to Inventive Example 1 using the powder having a grading range of zero to 0.1 μm. This results from an excessively large grain size in the natural diamond powder used as a starting material.

### Inventive Example 2

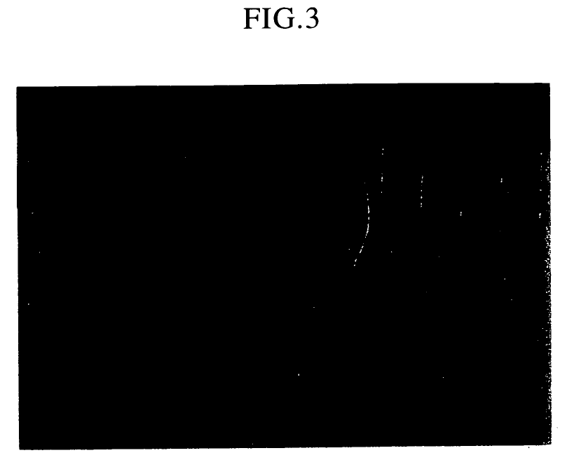

Except that the sintering treatment was performed at a temperature of 2150° C. for 20 minutes, a sintered body was produced in the same manner as that in Inventive Example 1. The obtained sintered body had a Vickers hardness of 115 GPa, and a thickness of 0.7 mm. As seen in FIG. 3, this sintered body had light-transparency, and scale marks of a measuring rule could be readily read through the sintered body. That is, a light-transparent diamond sintered body could be synthesized under a pressure of less than 10 GPa.

### Comparative Example 2

Except that the sintering treatment was performed under a pressure of 7.7 GPa at a temperature of 2300° C. for 10 minutes, a sintered body was produced in the same manner as that in Inventive Example 1. During grinding, the obtained sintered body exhibited no grinding resistance. This results from the sintering pressure set at less than 8.5 GPa. According to measurement of electric resistance, it was proven that the sintered body has an electric conduction property. This electric conduction property would be created by graphitization in the surface of each diamond grain.

### Inventive Example 3

Except that the sintering treatment was performed under a pressure of 9.4 GPa at a temperature of 1800° C. for 30 minutes, a sintered body was produced in the same manner as that in Inventive Example 1. During grinding, the obtained sintered body exhibited a high grinding resistance. According to measurement of Vickers hardness, it was proven that the obtained sintered body has an extremely high hardness of 100 GPa even in the sintering treatment performed at a temperature of 1800° C.

### INDUSTRIAL APPLICABILITY

The diamond sintered body of the present invention has a grain size of 100 nm or less in an electron microscope observation and a high Vickers hardness of 80 GPa or more, and consists of homogeneous fine grains without any abnormal grain growth. Thus, the diamond sintered body is excellent in wear/abrasion resistance and heat resistance, and workable into a shape with a sharp blade edge. For example, when this diamond sintered body is used in a finishing cutting work for a difficult-to-machine material, such as high-Si—Al alloy, or an ultraprecision machining process for metal or alloy, it can exhibit an excellent cutting performance.

Further, while a diamond sintered body using a sintering aid has opacity, the diamond sintered body of the present invention has no diffraction line other than that of diamond in powder X-ray diffractometry, and light-transparency providing clear visibility of characters or the like therethrough. Thus, the diamond sintered body of the present invention is useful as a wear-proof material requiring light-transparency (e.g. a window material for missiles or hydrothermal reaction vessels, or a pressure member for generating a high pressure), and valuable as jewelry goods.

What is claimed is:

1. A high-purity high-hardness ultrafine-grain diamond sintered body having a grain size of 100 nm or less, which is produced by subjecting an ultrafine-grain natural diamond powder having a grading range of zero to 0.1 μm to a desilication treatment, freeze-drying the desilicated powder in solution, and sintering the freeze-dried powder without a sintering aid.

2. The high-purity high-hardness ultrafine-grain diamond sintered body as defined in claim 1, which has light-transparency.

3. A method of producing a high-purity high-hardness ultrafine-grain diamond sintered body, comprising the steps of:
subjecting an ultrafine-grain natural diamond powder having a grading range of zero to 0.1 μm to a desilication treatment;
freeze-drying the desilicated powder in solution;
enclosing the freeze-dried powder in a Ta or Mo capsule; and
heating and pressurizing the capsule using an ultrahigh-pressure synthesizing apparatus at a temperature of 1700° C. or more and under a pressure of 8.5 GPa or more, which meet the conditions for diamond to be thermodynamically stable, so as to sinter the freeze-dried powder.

4. The method as defined in claim 3, wherein said heating and pressurizing step is performed at a temperature of 2150° C. or more and under a pressure of 8.5 GPa or more, whereby the sintered body has light-transparency.
